(19) United States
(12) Patent Application Publication
(10) Pub. No.: US 2009/0234634 A1
(43) Pub. Date: Sep. 17, 2009

(54) Method for Automatically Modifying A Machine Translation and A System Therefor

(76) Inventors: Shing-Lung Chen, Kaohsiung (TW); Chen-Sung Chang, Nantou County (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/332,424

(22) Filed: Dec. 11, 2008

(30) Foreign Application Priority Data
Mar. 12, 2008 (TW) 097108746

(51) Int. Cl. G06F 17/28

(52) U.S. Cl. 704/2

(57) ABSTRACT

A method for automatically modifying a machine translation includes the steps of: providing a source language; generating a target machine translation language according to the source language by means of machine translation; defining at least one of error types of the target machine translation language; designating at least one of correction modes according to the defined error type; generating a revised target language by executing the designated correction mode. A machine-translation-modifying system of a preferred embodiment includes a translation-editing database and a relationship model provided therein. Each of the relationship models is formed with at least one first language structure (source language), at least one second language structure of machine translation (target language), at least one error type, at least one correct second language structure and at least one correction mode.

### BACKGROUND OF THE INVENTION

1. Field of the Invention

The present invention relates to a method for automatically modifying a machine translation and a system therefor. More particularly, the present invention relates to the method and the system automatically modifying the machine translation by using several correction modes.

2. Description of the Related Art

Translation between two languages is well known in the art. Currently, there is a machine translation software system which is a more common system available on the market. Examples of such machine translation software systems commercially available in Taiwan are “Systran™” software manufactured by Systran software Inc., France (http://www.systransoft.com), “CCID™” software manufactured by CCID Trans Tech. Co., People Republic of China (http://www.ccidtrans.com), and “Dr.eye™” software manufactured by Inventec Corporation, Taiwan (http://www.dreye.com/tw). Such machine translation systems can automatically and rapidly translate a first language into a second language. In full-text translation, such systems always generate translation errors of a target language due to differences in language grammar and vocabulary.

In using such a machine translation system, a human translator must manually review an untranslated text of the source language and must manually revise errors existing in a translated text of the target language that further increases total translation costs. In view of this demand, there are several translation-editing service companies. Examples of well-known service companies are Vialanguage Inc., USA (http://www.vialanguage.com), Toggletext-Post-editing Service, Australia (http://www.toggletext.com), and Pre & Post Editing Services, USA (http://www.per-se.com). In addition to the human translation editing, complete human translations are often very accurate but they are also very expensive.

Another problem with such a machine translation system is that similar translation errors repeatedly appear during use. In this circumstance, a human translation editor must repeatedly correct such translation errors that result in wasting time and an increase of total cost. Accordingly, there exists a need of analyzing and modeling such translation errors, and also exists a need for a translation-editing system which can automatically revise such translation errors.

As is described in greater detail below, the present invention intends to provide a method for automatically modifying a machine translation and a system therefor in such a way as to mitigate and overcome the above problem.

### SUMMARY OF THE INVENTION

The primary objective of this invention is to provide a method for automatically modifying a machine translation by using several preset correction modes. The preset correction modes are used to automatically identify a translated target language so as to revise translation errors. Accordingly, the method of the present invention is successful in automatically modifying the machine translation language.

Another objective of this invention is to provide a system for automatically modifying a machine translation with several correction modes. The correction modes are provided in the system and are executed to automatically identify a translated target language so as to revise translation errors. Accordingly, the system of the present invention is also successful in automatically modifying the machine translation language.

The method for automatically modifying a machine translation in accordance with an aspect of the present invention includes the steps of:

providing a source language;

generating a target machine translation language according to the source language by means of machine translation;

defining at least one of error types of the target machine translation language;

designating at least one of correction modes according to the defined error type; and

generating a revised target language by executing the designated correction mode.

In a separate aspect of the present invention, the error types and the correction models are provided in a translation-editing database.

In a further separate aspect of the present invention, the error types are designed to be corresponding to target machine translation language generated from at least two different machine translation software.

The system in accordance with an aspect of the present invention includes:

at least one translation-editing database; and

at least one relationship model provided in the translation-editing database, the relationship model formed with at least one first language structure (source language), at least one second language structure of machine translation (target language), at least one error type, at least one correct second language structure and at least one correction mode;

wherein the relationship model is designated to operate the correction mode according to the second language structure and the related error type with respect to the first language structure such that at least one revised second language is generated according to the correct second language structure.

In a separate aspect of the present invention, the translation-editing database is linked with at least one machine translation system.

In a further separate aspect of the present invention, the machine translation system is selected from at least one or more machine translation software.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a flow chart of an establishing method of a system for automatically modifying a machine translation in accordance with a preferred embodiment of the present invention.

FIG. 2 is a block of the system for automatically modifying a machine translation in accordance with a preferred embodiment of the present invention.

### DETAILED DESCRIPTION OF THE INVENTION

It is noted that a system for automatically modifying a machine translation in accordance with the present invention can be implemented on a variety of different computing equipment, including stand-alone personal computers, networked computers, laptop computers, workstations, or the like; and an establishing method for the system of the present invention can be formed with computer-executable process steps.

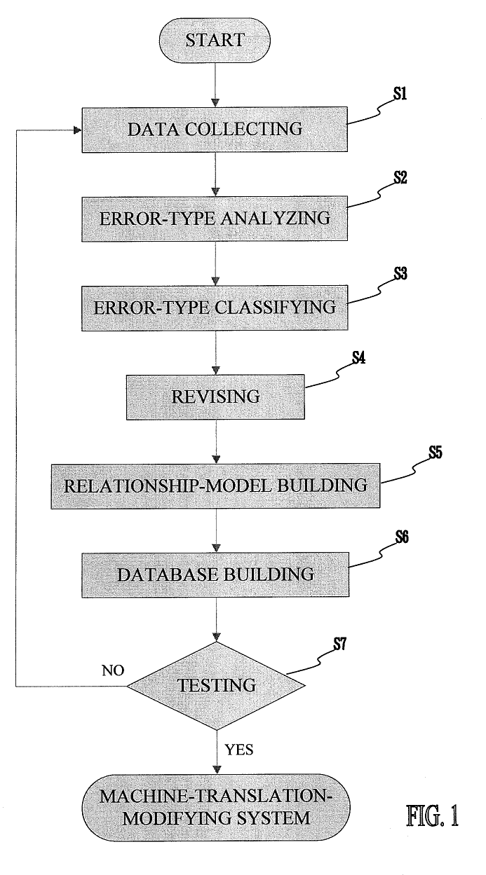

Referring initially to FIG. 1, an establishing method of the system in accordance with a preferred embodiment of the present invention includes the steps of:

Data collecting (identified as step S1): Collecting bilingual or multilingual texts of specialized fields via Internet by using an agent system, wherein the bilingual texts contain at least one source language structure (i.e. first language) corresponding to at least one target language structure (i.e. second language).

In a preferred embodiment, at least two different machine translation software systems are used to translate a predetermined text of the source language into a translated text of the target language. There are at least two types of machine translation structures generated from at least two of the machine translation software systems. For instance, the machine translation software applied in the present invention may be available from Babylon translation software, Google translator service or Worldlingo language translation services.

Error-type analyzing (identified as step S2): Comparing machine translation structures with correct target language structures so as to analyze error types existing in the machine translation structures. In a preferred embodiment, the error types are designed to be corresponding to target machine translation language generated from at least two different machine translation software.

In translation practice, a term in a source language may have more than one translation in a target language depending upon the subject, topic or field of the text being translated. In a preferred embodiment, one or both of semantic analysis software and contextual analysis software (e.g. “Morphix™” software) are used to analyze the sentence structures. In this circumstance, a degree of repeated error types generated from the same or different machine translation software is calculated. Accordingly, whichever error type may have a degree of repeated occurrence resulted from the same or different machine translation software.

Error-type classifying (identified as step S3): Classifying the repeated error types of the machine translation structures according to the target language structures or the specialized fields.

In a preferred embodiment, the error types may be classified depending upon the subject, topic or technical field of the source language. For instance, the error types may be classified into chemistry, medicine, computer science or mechanical engineering.

Revising (identified as step S4): Correspondingly linking each of the error types to the correct target language structures to form correction modes of the machine translation for use in revising the machine translation.

Relationship-model building (identified as step S5): Correspondingly connecting each of the error types with related elements of the target language structure, the correct target language structure and the correction mode so as to form a relationship model;

Table 1 shows three examples of the relationship models (G1, G2, G3) generated by the establishing method of the system in accordance with a preferred embodiment of the present invention. Each of the relationship models (G1, G2, G3) has one of the corresponding foreign language structures (F1, F2, F3) of source language, one of the corresponding machine translation structures (C1, C2, C3) of target language (e.g. Chinese), one of the corresponding error types (E1, E2, E3), one of the corresponding correct language structures (CC1, CC2, CC3) of target language, and one of the corresponding correction modes (CM1, CM2, CM3).

TABLE 1
Relationship models generated by the establishing method of the automatically
modifying machine translation system in accordance with the present invention.

| | | | | | |
|---|---|---|---|---|---|
| Model | Foreign lang. | Machine translation | Error types | Correct lang. | Correction |
| (G1) | structure (F1) | structure (C1) | (E1) | structure (CC1) | mode (CM1) |
| Model | Foreign lang. | Machine translation | Error types | Correct lang. | Correction |
| (G2) | structure (F2) | structure (C2) | (E2) | structure (CC2) | mode (CM2) |
| Model | Foreign lang. | Machine translation | Error types | Correct lang. | Correction |
| (G3) | structure (F3) | structure (C3) | (E3) | structure (CC3) | mode (CM3) |

In Table 1, “G” represents relationship models; “F” represents foreign language structures (i.e. first language); “C” represents Chinese language structures of machine translation; “E” represents error types of machine translation; “CC” represents correct language structures in Chinese; “CM” represents correction modes.

Database building (identified as step S6): Collecting a number of the relationship models to build a translation-editing database, a SQL database for example.

Testing (identified as step S7): One bilingual text of the source language and the translated target language is processed in the translation-editing database to generate a revised target language in order to test the system. Users can review the revised target language to confirm if the translation-editing database is operable. Users can repeat Steps 1 through 7 to further add a new error type of machine translation to the system if required.

The method for conducting a process for automatically modifying a machine translation in accordance with a preferred embodiment of the present invention includes the steps of:

providing a source language which may be selected from a first computer-readable file;

generating a target machine translation language according to the source language by means of machine translation which is selected from machine translation software, wherein the target machine translation language may be provided in a second computer-readable file;

defining at least one of error types of the target machine translation language, wherein the error types may be provided in a translation-editing database, and wherein the error types may be selected from a first computer-executable file;

designating at least one of correction modes according to the defined error type, wherein the correction modes may be provided in the translation-editing database, and wherein the correction modes may be selected from a second computer-executable file; and

generating a revised target language by executing the designated correction mode, wherein the revised target language may be displayed on a computer monitor or may be provided in a computer file such as a WORD-format file.

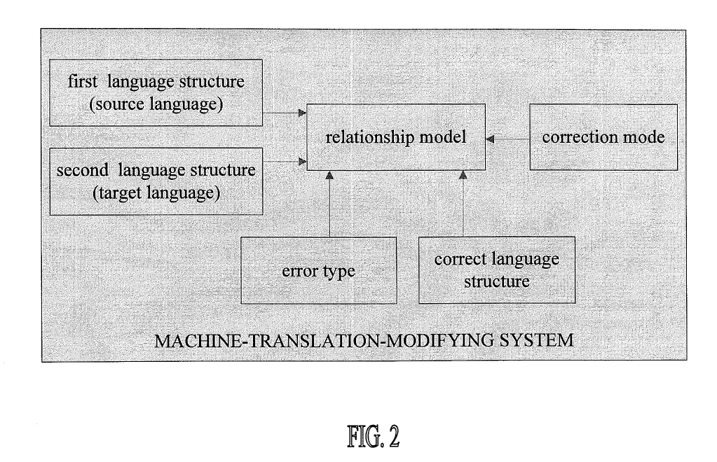

Turning now to FIG. 2, a machine-translation-modifying system in accordance with a preferred embodiment of the present invention is shown. The system in accordance with a preferred embodiment of the present invention includes at least one translation-editing database, and at least one or a plurality of relationship models provided in the translation-editing database. Each of the relationship models formed with at least one first language structure (source language), at least one second language structure of machine translation (target language), at least one error type, at least one correct second language structure and at least one correction mode.

Still referring to FIG. 2, one of the relationship models is designated to operate the correction mode according to the second language structure and the related error type with respect to the first language structure such that at least one revised second language is generated according to the correct second language structure.

The error types may be different in target machine translation language which are generated from different machine translation software. However, the error types suitable for one machine translation software may not be suitable for others. To solve this task, the error types are designed to be corresponding to target machine translation language generated from at least two different machine translation software. In operation, computing equipment is used to operate the system for automatically modifying machine translation.

Referring again to FIG. 2, in a preferred embodiment, the translation-editing database is linked with at least one machine translation system which may be selected from at least one or more machine translation software. For instance, the machine translation software may be English-to-Chinese translation software, France-to-German translation software, or English-to-German translation software.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. An establishing method for a system for automatically modifying a machine translation, comprising the steps of:
collecting bilingual or multilingual texts;
comparing machine translation structures with correct target language structures so as to retrieve error types of the machine translation;
classifying repeated error types of the retrieved error types of the machine translation structures;
correspondingly linking each of the error types to the correct target language structures to form correction modes of the machine translation;
correspondingly connecting each of the error types with related elements of the target language structure, the correct target language structure and the correction mode so as to form a relationship model; and
collecting a number of the relationship models to build a translation-editing database.

2. A method for automatically modifying a machine translation, comprising the steps of:
providing a source language;
generating a target machine translation language according to the source language by means of machine translation;
defining at least one of error types of the target machine translation language;
designating at least one of correction modes according to the defined error type; and
generating a revised target language by executing the designated correction mode.

3. The method as defined in claim 2, wherein the error types and the correction models are provided in a translation-editing database.

4. The method as defined in claim 2, wherein the error types are designed to be corresponding to target machine translation language generated from at least two different machine translation software.

5. A system for automatically modifying a machine translation, comprising:
at least one translation-editing database; and
at least one relationship model provided in the translation-editing database, the relationship model formed with at least one first language structure, at least one second language structure of machine translation, at least one error type, at least one correct second language structure and at least one correction mode;
wherein the relationship model is designated to operate the correction mode according to the second language structure and the related error type with respect to the first language structure such that at least one revised second language is generated according to the correct second language structure.

6. The system as defined in claim 5, wherein the translation-editing database is linked with at least one machine translation system.

7. The system as defined in claim 6, wherein the machine translation system is selected from at least one or more machine translation software.
